(19) United States
(12) Patent Application Publication
(10) Pub. No.: US 2008/0216404 A1
(43) Pub. Date: Sep. 11, 2008

(54) Plant Growth Module

(75) Inventor: Bernard Colin Jarvis, Sheffield (GB)

Correspondence Address: GOMEZ INTERNATIONAL PATENT OFFICE, LLC, 1501 N. RODNEY STREET, SUITE 101, WILMINGTON, DE, 19806, US

(73) Assignee: SUPAPLANTS LIMITED, Sheffield (GB)

(21) Appl. No.: 11/912,891

(22) PCT Filed: Apr. 25, 2006
(86) PCT No.: PCT/GB06/01514

§ 371 Date: Nov. 17, 2007

(30) Foreign Application Priority Data
Apr. 27, 2005 (GB) 0508500.6
Apr. 25, 2006 (GB) PCT/GB2006/001514

(51) Int. Cl. A01G 9/10

(52) U.S. Cl. 47/59 S; 47/59 R

(57) ABSTRACT

A module of plant growth medium for use in horticulture (2), comprises a container having at least one wall (4), which defines a reservoir (10) adapted to receive a cutting (22). The reservoir contains a viscous aqueous thixotropic planting fluid (12). The wall of said container comprises a further plant growth medium. The module provides a means for the improved propagation of plant cuttings, such as may result from improved rooting, reduced handling of cuttings and minimal root disturbance when planting on.

The present invention concerns modules of plant growth media for use in horticulture. In particular, though not exclusively, the present invention concerns modules of plant growth media for propagating plants by the rooting and growing-on of cuttings, which are placed in the pre-formed modules.

The propagation of plants from plant cuttings is widely practised in horticulture and a wide variety of growth media for this application are known. To propagate some cuttings, a section of plant stem is removed from a plant and a portion of the cutting so formed is placed in a growth medium, with the objective of the cutting growing roots in the growth medium and establishing itself as a viable plant. Whilst an ordinary soil may be used as a growth medium, success rates for rooting cuttings in soil can be relatively low. The soil requires retention in a container, e.g. a plant pot or walled tray, to provide a module suitable for handling in commercial horticulture.

Artificial compositions of optimised growth media are commercially available, such as media based on rockwool; pulverised or composted plant materials such as bark, coir, peat and/or other cellulosic based materials; lignin; other plant matter; soil; sand; and combinations of these materials. These compositions may also include plant nutrients. These compositions are also often supplied for use in the form of modules, commonly known as plugs. The plugs may be self-supporting in that they do not essentially require a container, such as a pot or multicellular tray, to retain their structure. Whilst plugs provide handling benefits when used for rooting cuttings, success rates for rooting, though often higher than in soil alone, can still be relatively low.

U.S. Pat. No. 3,973,355 discloses plugs in the form of a self-contained, dimensionally stable matrix for the germination of seeds and the growth of plants. Similar plugs based upon a foamed matrix are disclosed in U.S. Pat. No. 3,373,009 and U.S. Pat. No. 2,988,441. GB-A-2216378 discloses a biodegradable carrier for seeds and/or seedlings comprising an open container body defined by a laminar wall at least part of which is foraminous, the container housing a seed support medium secured into the container by support medium retention means. The medium may be particulate, paste, gel or liquid, and the retention means an adhesive forming a skin on the surface of the medium, a metal foil or wax layer.

A growth regulator, in the form of a powder, liquid or gel dip, is often used to improve success rates of rooting in soils and artificial growth media. The cutting is dipped into the powder, liquid or gel before it is placed in the growth medium and firmed into position. The handling of the cutting in this three step process may damage the cutting, especially if the cutting is physically delicate.

Cuttings may also be propagated by inserting a portion of the cutting into a viscous aqueous planting fluid such as a translucent, aqueous propagating fluid and allowing the cutting to root in the fluid. Translucent, aqueous thixotropic planting gels are described in GB-A-2171986, GB-A-2188044 and GB-A-2229716. Such fluids are commonly used in single propagating pots and in multicellular propagating trays, such as disclosed in GB-A-2194124. The pots or trays may be modified to screen the rooting gel from light of certain wavelengths, as disclosed in GB-A-2229716. Aqueous planting fluids are particularly suitable for the rooting of some cuttings but improvements are still required for optimal rooting and subsequent growth of others.

Storage stability for gel compositions can be a problem as a loss of physical properties, such as thixotropy, and efficacy, such as from dehydration or deactivation of growth promoters may occur over time. Storage is a particular issue for retail sales where long shelf life is required before use. For example, it is known that the structural integrity of a gel over time may be dependent on the type of container in which it is placed, as described in GB-A-2171986. Plant growth containers made of conventional transparent polystyrene, polyethylene, or polyvinyl chloride, may crack or split due to loss of water in the gel through the walls of the container. The problem can be overcome by using plant growth containers made of materials with very low water transmission rates. Additionally, for both commercial and retail use, gels require robust containers, which do not in themselves contribute to plant growth, but are strong enough resist breakage during transportation and handling.

The use of gels also gives rise to problems when a rooted cutting has to be planted on. Root deformation or damage may occur when removing a rooted cutting from its container. This may occur because gels tend to adhere to containers in which they are placed and either a container has to be broken away from a semi-solid gel or a thinner gel distorts or spills, when planting-on a rooted cutting. The handling of a cutting during planting-on is also therefore a three step process requiring gripping of a cutting, removing the container for the gel and planting. This process may also result in damage to a rooted cutting, especially when the cutting is physically small and/or delicate cuttings or plant parts, such as those plant products derived from micropropagation.

An object of the present invention is to deliver improvements in terms of one or more of (i) faster root formation, (ii) enhanced number of roots per cutting, (iii) more rapid (subsequent) root growth, and (iv) improved success rate, as measured by the provision of viable plants from cuttings. Another object is to improve the propagation of some physically delicate cuttings.

The present invention in its various aspects is as set out in the accompanying claims.

According to a first aspect of the present invention there is provided a module of plant growth media, which module is pre-formed for subsequent use in horticulture, the module comprising a container having at least one wall which defines at least one reservoir, wherein the or each reservoir contains a plant growth medium in the form of a viscous aqueous planting fluid, wherein said at least one wall of said container comprises a further plant growth medium, and wherein the viscous aqueous planting fluid is an aqueous thixotropic gel. Preferably the reservoir is suitable for receiving, in use, a cutting. Preferably the at least one reservoir is a dibble, i.e. a cavity formed in a planting medium using a dibble.

Growth in the sense of the invention encompasses enlargement and differentiation of plant tissue and organs.

Preferably, the module of plant growth media is self-supporting.

Preferably, the further plant growth medium (hereinafter ‘plant growth medium’) is a solid porous hydrophilic matrix. The hydrophilic matrix preferably comprises rockwool; pulverised or composted plant materials such as bark, coir, peat and/or other cellulosic based materials; lignin; other plant matter; soil; sand; vermiculite, pearlite, mica polystyrene beads, clay, volcanic ash, composted organic matter or combinations of two or more of these materials. The medium is preferably formed of a substantially organic material. Suitable clays include clay granules such as Seramis™, and Hydroleca™. The medium may optionally contain additional plant nutrients.

Most preferably the module is a self contained unit, by which is meant that the module is capable of providing all the physical support, nutrition and rooting medium required for the propagation of a plant cutting and which is itself not requiring, in normal use, any external means of support or containment. Normally, additional water may be supplied to the plant growth medium, but may not necessarily be required for propagating cuttings in initial use (days) or even for prolonged use (months), when used in a moist environment.

The invention can be used for the propagation of softwood, greenwood and semi-hardwood cuttings, such as Buddleia, Choisya, Cotoneaster, Forsythia, Fuchsia, Geranium, Hebe, Hydrangea, Privet, Pyrocantha and Spiraea.

A module of plant growth media according to the invention may be used to propagate a cutting as follows: an appropriate section of a plant stem is removed from a plant and a portion of the cutting so formed is placed in the viscous aqueous planting fluid contained in the reservoir of the module. The cutting is then left to root in the module. Thus, a usual three step operation when propagating a cutting using a plug can be reduced to a two step operation, particularly if a growth regulator is incorporated in the viscous aqueous planting fluid. After rooting the cutting in the module, the module and rooted cutting can be planted-on into soil, such as soil in a garden or inset into a block of growth medium which may be the same or different to the medium comprising the wall(s) of the container of the module of the invention. The two step operation when planting-on a cutting from a gel is reduced to a one step operation. From the above, it will be appreciated by those skilled in the art that the module of the present invention per se does not comprise a plant cutting (it does not comprise live plant material).

Use of the present invention therefore enables reduced handling of cuttings during plant propagation and subsequent establishment. Reduced handling is beneficial when delicate cuttings susceptible to damage are propagated. Additionally there is minimal disturbance to root growth between the container and a surrounding medium. This is particularly advantageous in large scale commercial horticulture where a large number of plants may require propagation.

According to a second aspect of the present invention there is provided a method of propagating a plant comprising the sequential steps of (i) providing a container having at least one wall comprising plant growth medium which defines at least one reservoir, which is preferably capable, in use, of receiving a cutting, (ii) placing in the at least one reservoir a viscous aqueous planting fluid which is in the form of an aqueous thixotropic gel, (iii) placing an appropriate portion of a plant cutting suitable for propagation into the viscous aqueous planting fluid in the reservoir. The method is particularly suitable for propagation of a plant from the cutting.

### The Viscous Aqueous Planting Fluid

The viscous aqueous planting fluid is a plant growth medium, i.e. a medium capable of supporting plant growth, such as by enabling root growth in and through the medium. The viscous aqueous planting fluid is a thixotropic gel. The viscous aqueous planting fluid may comprise a plant growth regulator, such as a plant growth hormone, to assist rooting of the cutting, but this is not essential for some species of plant. The viscous aqueous planting fluid may be transparent or translucent.

Preferably, the viscous aqueous planting fluid is an aqueous inorganic thixotropic gel. Preferably, the inorganic thixotropic gel comprises a hydrated magnesium silicate. Preferably, the inorganic thixotropic gel comprises a gel such as disclosed in GB-A-2171986, GB-A-2188044 or GB-A-2229716, which are incorporated herein by reference. An aqueous inorganic thixotropic gel is preferred as such gels retain their integrity in-situ and do not break down or absorb into a planting medium of the type hereinbefore described, unlike gels derived from organic gellation aids, which are liable to fungal and/or microbiological degradation.

The viscous aqueous planting fluid may be a gel derived from the use of one or more organic gellation aids. Suitable organic gellation aids are known to persons skilled in the art.

When left under normal atmospheric conditions, a thixotropic gel does not flow without the application of a shear force. Accordingly, once inserted into the reservoir of the module and the module left in a room under normal atmospheric conditions for a long period of time, the thixotropic gel is substantially retained in the reservoir as it does not flow out of the reservoir under its own weight into the further plant growth medium. When a shear force is applied to the gel, such as when a cutting is forced into the thixotropic gel, the gel flows in the vicinity of the shear force to receive and flow around the cutting, thereby to fully encapsulate the cuffing end. Once the shear force is removed, the gel returns to its non-flowing state. In contrast, a non-thixotropic gel would be expected over time to flow out of the reservoir into the further plant growth medium. Further, a non-thixotropic gel which is of sufficiently high viscosity so as not to readily flow out of the reservoir into the further plant growth medium does not undergo shear thinning. The lack of shear thinning in such a high viscosity non-thixotropic gel can lead to damage of cuttings, particularly delicate cuttings, by the action of forcing the cuttings into the non-thixotropic gel and, as the non-thixotropic gel will not readily flow around the cutting to fully encapsulate the cutting end, can lead to poor root formation.

The viscous aqueous planting fluid is preferably a propagating fluid, which is a planting fluid comprising at least one plant growth regulator, such as a hormone, which is suitable for encouraging and/or developing growth of roots on a plant cutting, developing seedling or for encouraging germination of a seed. In one particular embodiment of the present invention, the planting fluid comprises both of at least one plant nutrient and at least one plant growth regulator, i.e. the fluid is a propagating fluid comprising at least one plant nutrient.

A suitable plant growth regulator, or auxin, is indolebutyric acid [4-(3-indolyl)butyric acid] or a salt thereof. Particularly preferred is the potassium salt of indolebutyric acid.

The concentration of plant growth regulator, such as indolebutyric acid, in the viscous aqueous planting fluid, may be from 5×10⁻⁸ to 5×10⁻² M, preferably from 1×10⁻⁷ to 5×10⁻³ M, most preferably from 1×10⁻⁵ to 2×10⁻³ M, wherein M designates a molar concentration. These concentrations can give enhanced root growth for cuttings of a range of plants. Higher or lower concentrations may give reduced root growth. These concentrations represent a significant reduction in optimal active ingredient concentration than when using a liquid rooting gel or powder rooting dip, which dips typically comprise 0.1 to 0.5 wt % of active ingredient (such as indolebutyric acid).

A viscous aqueous planting fluid, dispenser and dispensing method therefore, all particularly suited for use in the present invention, can be found in WO2004066717 which is incorporated herein by reference.

A suitable growth regulator for encouraging germination of a seed is gibberellic acid. The viscous aqueous planting fluid may comprise gibberellic acid or other gibberellin.

A viscous aqueous planting fluid for use in the invention may comprise one or more plant nutrients.

The or each reservoir in the module of the present invention preferably comprises at least 0.5 ml of viscous aqueous planting fluid.

When a transparent or translucent viscous aqueous planting fluid is used in the present invention a portion of the fluid may be exposed or reversibly exposable on the surface of the medium to enable visual inspection of any root growth in the medium. This has an advantage that the time when a cutting is ready for planting-on may be better judged by visual inspection, leading to higher success rates in propagation. This is not possible with conventional plugs.

Additionally, when a transparent or translucent viscous aqueous planting fluid is used in the present invention in a manner where it is exposed to light the fluid may comprise a colorant. The colorant may adsorb red and/or blue light so as to enhance rooting. Preferably such a colorant adsorbs light having a wavelength longer than 550 nm, more preferably also from light having a wavelength shorter than 450 nm. Thus, any incident light on a portion of the stem submerged in the fluid in use is most preferably of a wavelength between 450 and 550 nm (which appears green to the normal human eye). The number of roots produced per cutting may by this means be increased over use of a fluid without colorant. Preferably a portion of the stem submerged is normally not exposed to any light.

### The Container

The container employed in the invention comprises at least one wall, and an optional base, which defines at least one reservoir (e.g. a dibble), which is preferably adapted to receive a cutting. The reservoir may be hemispherical, thus having only one wall, or may be cylindrical, the cavity then comprising one wall and a circular base portion. The container may comprise a plurality of reservoirs. The reservoirs may be arranged in the form of a substantially planar array in the form of a tray. The containers may be adapted to receive a cutting by means of an aperture pre-formed in a wall of the reservoir.

In one embodiment the container employed in the invention preferably comprises a self-supporting, dimensionally stable, porous and hydrophilic matrix suitable for supporting root growth, such as disclosed in U.S. Pat. No. 3,973,355, incorporated herein by reference.

A self-supporting container is one which does not require any external lateral support in normal use and handling, such as after watering or during lifting when planting-on. Thus the module of the invention can be handled as a self contained entity supplying all the needs for propagation of a cutting. However, for ease of handling, such as when handling multiple modules of plant growth medium a plug tray may be used. A propagator may also be used to house one or more modules of plant growth medium according to the invention.

The module may be used with a means of external support. A means of external support includes items such as plant rings, bags or nets, including biodegradable formaminous bags and netting, plant pots (e.g. those formed from terracotta or plastics) and plastics walled-trays. Though plant roots may pass through such means of external support as a plant grows in the module, the means of external support per se will not be capable of supporting plant growth.

A container which comprises a hydrophilic matrix may soak up and retain a relatively large quantity of water, to help maintain hydration about a cutting for improved rooting.

A container which is porous facilitates root growth when planting-on a rooted cutting and, in particular, a porous wall of the container may permit lateral root growth into a medium in which the module of the invention may be planted-on.

In another embodiment, compressed peat plugs may be used as the container of the invention, but such plugs may not be dimensionally stable due to shape distortion on changes in hydration. It is desirable to provide a hydrophilic plant growth matrix, which will not separate into layers or disintegrate on handling or wetting and rewetting and which are nontoxic to plants.

Containers used in the present invention can be readily biodegradable, such as when composed of organic materials. Additionally, containers used in the invention may contribute functionality by acting as a growing medium in their own right. U.S. Pat. No. 3,973,355 describes a suitable container.

The containers for use in the invention are porous and enable roots established in the viscous aqueous planting fluid portion of the growth matrix to penetrate the container and, after planting-on, such as in soil, roots will continue to grow outward. Such root growth is advantageous as no interruption of natural root development occurs when using a growth medium according to invention. Hence, use of the present invention for plant propagation permits planting or transplanting with minimum root shock, i.e. planting requires only a surrounding of the plant growth medium with, for example soil or a block of growth medium which may be the same or different to the media comprising the module of the invention. Roots are therefore not disturbed on planting and root growth may progress laterally and basally from external faces of the plant growth medium into such soil, such that any check or disturbance to root growth is minimised.

The medium used for the containers preferably has adequate air filled porosity, such as at least 10%, for good root growth. Air filled porosity is a term of art (such as described in Media and Mixers for Container-Grown Plants, A. C. Bunt, ISBN 0-04-635016-0) defining the proportion of the volume of medium that contains air after it has been saturated with water and allowed to drain.

The container for use in the invention may comprise a water absorbable bonded mixture of particles of various conventional plant growing media, such as vermiculite, perlite, rockwool, sand, sawdust, wood fibre, tree bark, coir, peat, topsoil and equivalents. A container may be made by mixing conventional plant growing media with a bonding polymer in particulate form before forming the media under pressure to form a container.

According to a third aspect of the invention there is provided a kit of parts. The kit of parts is preferably suitable for propagation of a plant cutting, most preferably to the propagation of a plant cutting according to one or more of the Examples herein. A kit comprises all the components of a module of plant growth media of the invention, comprising at least a container and a viscous aqueous planting fluid. The kit optionally provides a container in the form of a plug, preferably a plug comprising a reservoir in the form of a dibble. The kit optionally provides a gel in a gel container, such as a bottle, separate from the container with the reservoir. The gel container may be hand holdable. The gel container (or dispenser) may be a bottle, a pump-action dispenser, a pressurised canister, or a pressurized, gravity fed or pumped tank. A squeezable bottle is preferred, such as a bottle for allowing controlled expulsion of gel from the bottle, such as expulsion through an elongate nozzle suitable for insertion into the reservoir, such as a dibble of the container. Such a bottle facilitates manually dispensing gel to fill a dibble, such a filling by means of dipping the elongate nozzle into the dibble before squeezing the bottle to controllably expel a portion of gel from the bottle into the dibble. This method and apparatus avoids forming air locks by the gel in the dibble. The viscous aqueous planting fluid may be provided in the form of hydrateable precursor therefor, for example in the form of a substantially dehydrated material, such as polymer granules or a clay tablet, hydrateable to form a homogenous fluid.

The kit of parts may also comprise instructions for preparing a module as described above. The instructions may be printed onto packaging containing the other parts of the kit, such as on a cardboard box, or they may be printed onto a leaflet included with the other parts of the kit within the packaging. The instructions may be printed on an external support for the module, such as on a plant pot or tray included within the kit.

The invention is now further described by way of example and with reference to the drawings, in which:

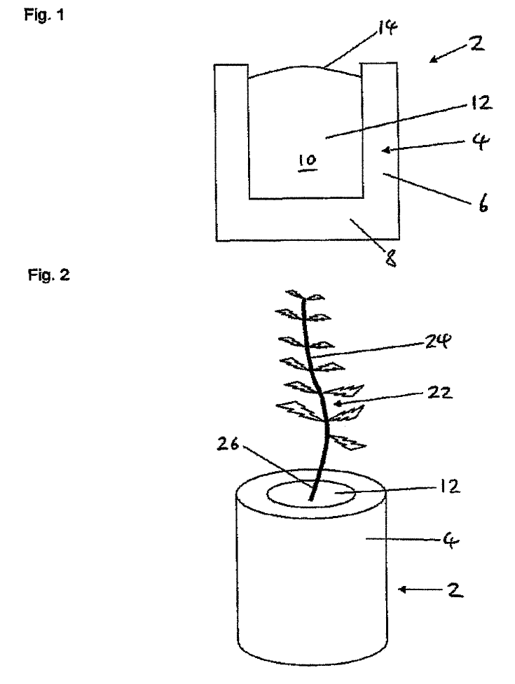

FIG. 1 shows a vertical cross section through a module of plant growth medium of the invention; and

FIG. 2 shows a module of FIG. 1, in use, for propagating a plant cutting.

Referring now to the figures:

A module of plant growth medium (2) according to the invention comprises a container (4) having a wall (6) and a base (8) which define a reservoir (10) substantially filled with a translucent viscous aqueous planting fluid (12) in the form of an inorganic thixotropic gel. The reservoir (10) is cylindrical. The container (4) acts as a matrix suitable for supporting root growth. The translucent viscous aqueous planting fluid (12) acts as a matrix suitable for supporting root growth, particularly initial root growth. The upper surface (14) of the viscous aqueous planting fluid (12) is exposed on an, in use, top side of the module of plant growth medium (2), such that visual inspection of the contents of the reservoir is possible.

In use, the module of plant growth medium (2) is combined with a cutting (22) in the form of a section of a plant stem removed from a plant (not shown). The plant cutting (22) comprises a first, upper, leafed portion (24) and a lower, rooting portion (26) which is inserted into the viscous aqueous planting fluid (12). The container (4) may be moistened in use but on occasion this may not be necessary. After a cutting (22) has rooted, the whole module (2) plus cutting (22) is directly inserted into soil or a larger block of planting medium for ongoing plant growth (i.e. planted-on) in soil for ongoing plant growth, such as may include rooting outside the container wall (6).

The experimental results shown in tables 1 to 5 below, using gel in a plug, were generated as follows. Propagation plugs were placed in trays and then saturated with water. Prior to application of gel the trays were placed in the base of a conventional propagator.

Using a dispenser in the form of a squeezable plastics bottle provided with an elongate dispensing nozzle the dibble of each plug was filled with gel dispensed from the bottle.

A single stem cutting of the type indicated in the relevant table was firmly placed directly into the gel. Appropriate cuttings were prepared according to “Plant Propagation” by P. McMillan Browse. ISBN 1 85732 903 1 and “Successful Propagation” edited by A. Ayres. ISBN 0 340 39981 3. A vented lid was placed on the propagator, which was kept outdoors under a North-facing wall in South Yorkshire, U.K. Species were tested between July and November 2004. Plugs were kept moist throughout the trial period. No further addition of gel to the plugs was made during these trials. For the comparative data where a plug only is specified, the above procedure was followed with the omission of the gel. Where gel only is specified a plastics plug tray was used in place of the plug. In these results a plug is a container of the invention, the gel is the viscous aqueous plant growth medium and plug plus gel is a module of plant growth medium. References to gel without mention of indole (indole butyric acid) are references to gel without any added auxin.

The following examples, expressed as tables 1 to 5, were performed in accordance with the above method of use.

TABLE 1

| Hebe | | Mean number | |
|---|---|---|---|
| cupressiforme | | Roots per | Mean root |
| cuttings | % rooted | cutting | length (mm) |
| plug | 70 | 3.4 ± 1.7 | 23.6 ± 6.1 |
| i.e. no gel | | | |
| Plug with gel | 95 | 3.3 ± 1.0 | 24.2 ± 6.3 |
| Plug with gel | 100 | 4.7 ± 1.0 | 39.9 ± 8.3 |
| and indole | | | |

The data in table 1 shows that the use of a plug with gel of the invention increases the percentage of cutting rooted by 25% over the comparison plug alone, i.e. one that does not contain a gel in a dibble. When a module of plant growth medium of the invention comprises an optional auxin in the form of indolebutyric acid the data indicate a further improvement. Compared to the control, the percentage of cuttings rooted increases by 30%, the mean number roots per cutting increases from 3.4 to 6.6 and the mean root length increases from 23.6 to 39.9 mm.

TABLE 2

| | Mean number of roots per | | | |
|---|---|---|---|---|
| | cutting | | Mean root length (mm) | |
| | | Plug with gel | | Plug with gel |
| Cuttings | Plug with gel | and indole | Plug with gel | and indole |
| Rosemary | 6.8 ± 1.3 | 12.6 ± 1.1 | 13.2 ± 4.5 | 25.9 ± 11.4 |
| Fuchsia | 7.8 ± 1.3 | 21.2 ± 2.2 | 13.4 ± 4.6 | 25.9 ± 3.8 |

TABLE 3

Time (days) to first root formation.

| Cuttings | Plug with gel | Plug with gel and indole |
|---|---|---|
| Rosemary | 14 | 9 |
| Fuchsia | 17 | 14 |
| Hypericum | 25 | 19 |

Tables 2 and 3 shows how the present invention is preferably practised using a gel comprising indole butyric acid as an auxin in the gel.

TABLE 4

| Hypericum | Mean number of roots | |
|---|---|---|
| cuttings | per cutting | Mean root length |
| Gel and indole | 13.4 ± 4.4 | 12.9 ± 3.1 |
| (i.e. no plug) | | |
| Plug with gel and | 24.0 ± 5.3 | 24.2 ± 1.9 |
| indole | | |

Table 4 further shows the advantage of the present invention. Use of a combination of plug and gel gives a greater number of roots per cutting and a greater root length when compared to use of a gel alone.

TABLE 5

Number of cuttings rooted in

| | Plug | Plug with gel and indole |
|---|---|---|
| Cotoneaster | 3/20 | 15/20 |
| Buxus | 8/20 | 16/20 |
| Buddleia | 6/30 | 26/30 |
| Forsythia | 15/20 | 17/20 |
| Spiraea | 7/20 | 20/20 |
| Total | 39/110 (35%) | 94/100 (85%) |

Table 5 shows cuttings evidencing root growth against (/) cuttings in the test. The results demonstrate an improved success rate when a gel is used in the dibble of a plug. The fractional success rate over the 5 genera tested is greater when using a module of the invention than when using a plug alone under the same conditions.

1. A module of plant growth media, which module is pre-formed for subsequent use in horticulture, the module comprising a container having at least one wall which defines at least one reservoir, wherein the or each reservoir contains a plant growth medium in the form of a viscous aqueous planting fluid, wherein said at least one wall of said container comprises a further plant growth medium, and wherein the viscous aqueous planting fluid is an aqueous thixotropic gel.

2. The module of claim 1 wherein the viscous aqueous planting fluid comprises a plant growth regulator and/or at least one plant nutrient.

3. The module of claim 1, wherein the aqueous thixotropic gel is an aqueous inorganic thixotropic gel.

4. The module of claim 2 wherein the aqueous inorganic thixotropic gel comprises a hydrated magnesium silicate.

5. The module of claim 1 wherein the at least one wall of the container is self-supporting.

6. The module of claim 1 wherein the at least one reservoir is a dibble.

7. The module of claim 1 wherein the further growth medium is a porous, hydrophilic matrix.

8. The module of claim 1 wherein the container is formed of at least one of rockwool; pulverised or composted plant materials such as bark, coir, peat and/or other cellulosic based materials, lignin, other plant matter, other organic matter; soil; clay; mica; volcanic ash; and sand.

9. The module of claim 1 wherein the container is a plug.

10. A module of plant growth media comprising a plug including a dibble, wherein the dibble is at least partially filled with a viscous aqueous planting fluid.

11. A method of propagating a plant comprising the following sequential steps of (i) providing a container having at least one wall comprising plant growth medium, which defines at least one reservoir, (ii) placing in the at least one reservoir a viscous aqueous planting fluid, wherein the viscous aqueous planting gel is an aqueous thixotropic gel, (iii) placing an appropriate portion of a plant cutting suitable for propagation into the viscous aqueous planting fluid in the reservoir.

12. A method of propagating a plant comprising the following sequential steps of (i) providing a container having at least one wall comprising plant growth medium, which defines at least one reservoir, (ii) placing in the at least one reservoir a viscous aqueous planting fluid, wherein the viscous aqueous plating gel is an aqueous thixotropic gel, (iii) placing an appropriate portion of a plant cutting suitable for propagation into the viscous aqueous planting fluid in the reservoir wherein the viscous aqueous planting fluid and/or the container are as described in claim 2.

13. A method of propagating a plant comprising the following sequential steps:
i) providing a module as claimed in claim 1 and
ii) planting an appropriate portion of a plant stem in the viscous aqueous planting fluid contained in the reservoir of the module.

14. A kit of parts suitable for preparing at least one module as claimed in claim 1, the kit comprising a container as defined in a claim 1, a viscous aqueous thixotropic planting fluid or hydrateable precursor therefore, and instructions for providing a module as defined in claim 1.

15. The kit of claim 14 further comprising the viscous aqueous planting fluid in the form of a thixotropic inorganic gel in a hand holdable gel container.

16. The kit of claim 15 wherein the hand holdable gel container is a manually squeezable bottle provided with an elongate nozzle suitable for insertion into a dibble of the container.

17. The kit as claimed in claim 14 wherein the kit further comprises a plant cutting and/or seeds or other appropriate portion of a plant for growth using the module.

19. A kit of parts comprising a plug having a dibble, a dispenser containing a viscous aqueous thixotropic planting fluid and instructions for providing a module as claimed in claim 1.

20. The method of claim 12 wherein the aqueous thixotropic gel is an aqueous inorganic thixotropic gel.

21. The method of claim 20 wherein the aqueous inorganic thixotropic gel comprises a hydrated magnesium silicate.
